(19) United States
(12) Patent Application Publication
(10) Pub. No.: US 2006/0082351 A1
(43) Pub. Date: Apr. 20, 2006

(54) Low power operation of back-up power supply

(76) Inventors: Marcus M. Martins, Richardson, TX (US); Jingwei Xu, Shanghai (CN)

Correspondence Address: TEXAS INSTRUMENTS INCORPORATED, P O BOX 655474, M/S 3999, DALLAS, TX, 75265, US

(21) Appl. No.: 10/966,194

(22) Filed: Oct. 15, 2004

(51) Int. Cl. G05F 1/56

(52) U.S. Cl. 323/268

(57) ABSTRACT

Systems and methods are disclosed to provide for low power operation of a back-up power supply. In one aspect, a back-up power supply system may include a switch system, such as a voltage regulator, that is coupled to provide an output voltage for charging a back-up power device up to about a predetermined voltage based on an input voltage. A charge pump is coupled to provide a pump voltage to the output voltage for charging the back-up power device up to about the predetermined voltage based on the output voltage exceeding the input voltage.

### TECHNICAL FIELD

This invention relates to integrated circuits, and more specifically relates to low power operation of a back-up power supply.

### BACKGROUND

Portable electronic devices, such as cellular telephones, cameras, and the like, continue to become increasingly complex. The increased complexity of these and other portable devices imposes burdens on power consumption and battery lifetime. Despite the additional features being implemented in various devices, the manufacturers of these devices and their customers typically require substantially the same or even improved battery lifetime. Additionally, some of the features need to be maintained even during low battery voltage conditions as well as no battery conditions, such as when a battery is being replaced.

In addition to battery lifetime, another typical requirement is that the portable device should be operative even when the battery has discharged to a low voltage level, for example about 2V. One common approach to overcome this situation is to implement the power supply system of the portable device to include a boost regulator. The boost regulator is operative to provide a constant voltage to the circuitry of the portable device even during the conditions of low voltage batteries. A back-up power supply also is associated with the converter or regulator for providing back-up power, such as during low power conditions as well as during conditions when the battery has been removed from the device. The back-up power supply can employ one or more super capacitors or ultra capacitors (e.g., Electric Double Layer Capacitors) to provide the back-up power. A super capacitor typically has the capacitance in the order of hundreds of milli Farads (F) or higher. Typically, the boost regulator is coupled to charge the super capacitor to a desired voltage, normally to maximize the charge to be stored in the super capacitor so as to maximize the back-up time provided by the super capacitor.

In order to keep the super capacitor charged to the desired voltage (e.g., to not jeopardize the back-up time), the boost regulator is generally turned on continuously, even when the portable device is turned off. Since the converter or regulator is coupled to drive various other loads in the system it normally drains a lot of current. Additionally, the boost regulator might output a voltage exceeding 5V, and since the converter or regulator charges the super capacitor in a generally direct manner, a sufficiently high voltage rated (e.g., expensive) super capacitor may be required to accommodate the higher voltage from the regulator. Accordingly, an improvement in a power supply technology is desired.

### SUMMARY

The present invention relates to low power operation for a back-up power supply. The low power operation can be employed to charge a back-up device up to a predetermined voltage level. The back-up device has sufficient power to provide adequate back-up power for a period of time, including when the battery is not present (e.g., when the battery is being replaced).

One aspect of the present invention provides a back-up power supply system that may include a switch system, such as a voltage regulator, that is coupled to provide an output voltage for charging a back-up power device (e.g., a super capacitor) up to about a predetermined voltage based on an input voltage. A charge pump is coupled to provide a pump voltage to the output voltage for charging the back-up power device up to about the predetermined voltage based on the output voltage exceeding the input voltage. The back-up power supply can be implemented as an integrated circuit, which can be utilized by an electronic device to provide back-up power during low power and back-up modes.

Another aspect of the present invention provides a back-up power supply system that includes a linear regulator. The linear regulator receives a variable input voltage, and provides an output voltage at a lower one of the input voltage and a predetermined voltage. A charge pump is coupled to increase the output voltage up to about the predetermined voltage based on the linear regulator being unable to provide the output voltage at the predetermined level based on the input voltage. A super capacitor is coupled at the output voltage, the super capacitor being charged by at least one of the linear regulator and the charge pump up to about the predetermined voltage.

### BRIEF DESCRIPTION OF THE DRAWINGS

FIG. 1 depicts a block diagram of a back-up power supply system in accordance with an aspect of the present invention.

FIG. 2 depicts an example of another back-up power supply system in accordance with an aspect of the present invention.

FIG. 3 depicts an example of a charge pump system that can be implemented in accordance with an aspect of the present invention.

FIG. 4 depicts an example of a pump core that can be implemented in accordance with an aspect of the present invention.

FIG. 5 is an example of a linear regulator that can be implemented in a power supply system in accordance with an aspect of the present invention.

FIG. 6 is a graph depicting voltage signals associated with operation of a back-up power supply system in accordance with aspect of the present invention.

FIG. 7 depicts an example of a portable electronic device implementing a power supply system in accordance with aspect of the present invention.

### DETAILED DESCRIPTION

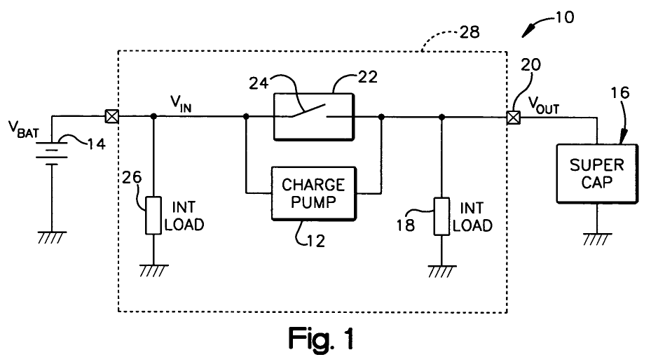

FIG. 1 depicts an example of a back-up power supply system 10 that can be implemented according to an aspect of the present invention. The back-up power supply system 10 includes a charge pump 12 arranged between a battery 14 and an associated charge storage device, such as a super capacitor or ultra capacitor (e.g., Electric Double Layer Capacitor) 16. The super capacitor 16 has a capacitance typically in the order of hundreds of mF or higher. As such, the super capacitor 16 is assigned a rating, which indicates that it can be charged safely up to a predetermined voltage. Once charged, the super capacitor 16 can supply power such as for an associated internal load 18 coupled to a terminal 20 of the system 10 to which the super capacitor is also coupled.

The system 10 can also include a switching system 22 that is coupled generally in parallel with the charge pump 12. The switching system 22 is operative to charge the super capacitor 16 up to a predetermined output voltage V_{OUT} based on an input voltage V_{IN}, which can be variable depending on a battery voltage V_{BAT}. During a normal operating mode, such as when V_{IN} is greater than the predetermined V_{OUT}, the switching system 22 can charge the super capacitor 16 to the predetermined V_{OUT} without requiring activation of the charge pump 12. A low power mode exists when V_{IN} is below an associated voltage (e.g., approximately equal to the predetermined V_{OUT}). When in the low power mode, the switching system 22 cannot charge the super capacitor 16 up to or maintain the predetermined V_{OUT}. The low power mode can occur when the electronic device in which the system 10 is implemented is turned off and the battery voltage V_{BAT} of the battery 14 falls below a predetermined threshold. When the electronic device is turned off, voltage regulators in the system would also be off.

During the low power mode, the charge pump 12 can be activated to charge the super capacitor 16 to up to the predetermined output voltage V_{OUT}. The charge pump 12 may operate in conjunction with the switching system 22 for providing supplemental charging of the super capacitor 16. Alternatively, the charge pump 12 can operate to charge the super capacitor 16 while the switching system 22 has been deactivated to an off condition, such as may occur based on V_{OUT} being charged to a voltage that is greater than V_{IN}. Those skilled in the art will understand and appreciate various topologies of charge pumps that can be utilized to provide V_{OUT} during the low power mode. For example, numerous topologies and charge pump techniques exist, including a voltage doubler configuration, which can be utilized to generate a voltage at V_{OUT} that exceeds V_{IN}.

By way of further example, the switching system 22 can be implemented as a linear regulator that is controlled (e.g., based upon a feedback or error signal) to maintain a desired output voltage V_{OUT} during the normal operating mode. The normal operating mode, for example, can occur while the device implementing the system 10 is turned on and/or while the voltage V_{BAT} of the battery 14 is at a voltage sufficient to enable the switching system 22 to charge up to the desired output voltage V_{OUT}. Thus, the switching system 22 can successfully maintain V_{OUT} at the desired level provided that V_{BAT} exceeds the desired level, namely the predetermined level for the output voltage V_{OUT}. Those skilled in the art will understand and appreciate various types and configuration of linear regulators that can be utilized to hold V_{OUT} at its desired level based on the teachings contained herein.

The switching system 22 also includes a pass device, indicated at 24, which includes at least one component that is electrically connected to provide a path between V_{OUT} and V_{IN}. During the low power mode, such as when V_{OUT} reaches a voltage that exceeds the charging capacity of the switching system, the pass device 24 is operated to electrically isolate V_{OUT} from V_{IN}. The pass device 24 can also electrically isolate V_{OUT} from V_{IN} during a back-up mode when neither the charge pump 12 nor the switching system 22 is charging the super capacitor 16. When the pass device 24 isolates V_{OUT} from V_{IN}, electrical current from the super capacitor 16 does not drain through the switching system 22 to other circuitry, such as including an internal load 26 connected at V_{IN}. Accordingly, the charge from the super capacitor 16 is available to power the other internal load 18. The internal load 26 may include voltage reference generators, converters and other resources that may require utilization of the V_{BAT} from the battery 14. However, use of such resources of the internal load 26 is not essential during the back-up mode and, if operated during the back-up mode, typically would drain power unnecessarily from the super capacitor 16.

Those skilled in the art will appreciate that the pass device 24, which forms part of the switching system 22, provides a dual purpose that varies according to the operating mode of the system 10. For example, during the normal operating mode, the pass device 24 can be controlled to supply the V_{OUT}, and, during a low power or back-up mode, the pass device can be turned off (e.g., open circuit) to prevent drain from the super capacitor 16. By providing the dual purpose pass device 24, efficiencies can be achieved to reduce the overall cost while providing desired performance.

The charge pump 12 and switching system 22 can be implemented as part of an integrated circuit indicated at 28. The internal load 18 can also be part of the integrated circuit. The internal load 18 can correspond to critical, core circuitry requiring continuous power. For example, internal load 18 may include a real time clock and/or non-volatile memory that holds critical data utilized during operation of the apparatus or article implementing the power supply system 10.

From the foregoing description system 10 of FIG. 1, those skilled in the art will further understand and appreciate that additional pins are not required other than to connect to the super capacitor 16. Additionally, by employing the switch system 22 in combination with the charge pump 12, the system 10 is able to maximize the voltage V_{OUT} on the super capacitor 16 even when a low voltage condition exist at V_{BAT}. Since the charge on the super capacitor 16 can be maximized, the amount of energy stored in the super capacitor can exceed that achieved by more traditional approaches. An additional efficiency is obtained by utilizing the pass device 24 as a switching device for providing V_{OUT} during a normal mode and providing an open circuit condition during a lower power mode for electrical isolation. This efficiency helps reduce the footprint of the circuit and mitigates the requisite die area needed for implementing the integrated circuit 28. Additionally, since the same switch is utilized by the regulator 22 and the charge pump 12, a smooth transition is facilitated when switching between a normal mode and a low power mode.

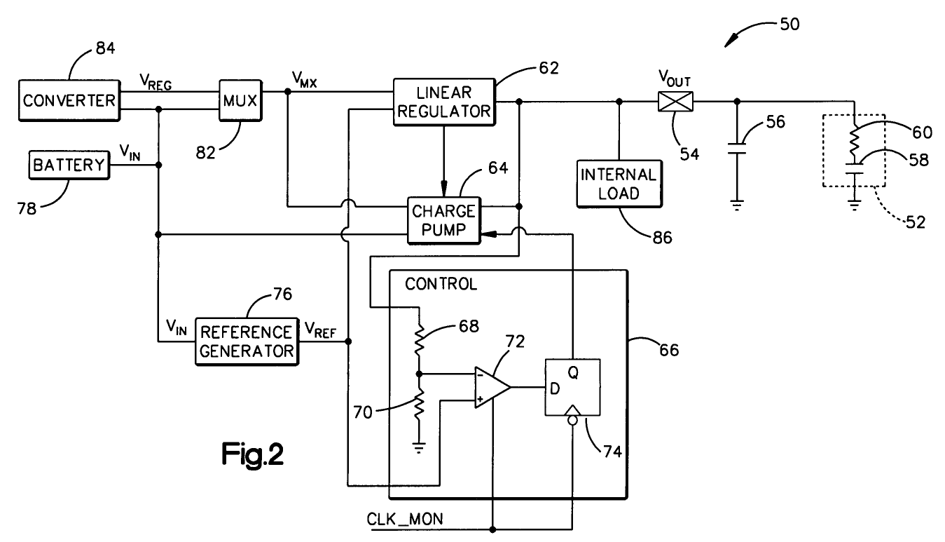

FIG. 2 depicts another example of a back-up power supply system 50 that can be implemented in accordance with an aspect of the present invention. The system 50 operates in a plurality of modes to facilitate charging a super capacitor to a desired output voltage V_{OUT}. A super capacitor 52 is connected at a terminal 54, such as connected to a pin of an integrated circuit that includes the power supply system 50. That is, the super capacitor 52 is depicted as an external device relative to an integrated circuit that includes the back-up power supply system 50.

The super capacitor 52 can be represented as including a capacitive portion 58 and an associated equivalence series resistance (ESR) 60. Since the ESR 60 of the super capacitor is normally a large value (e.g., about 200 Ohms), a filtering capacitor 56 can be connected in parallel with the super capacitor 52 (between the terminal 54 and electrical ground) to mitigate noise that may be generated by the internal load 86. As an example, the filtering capacitor 56 can have a capacitance in the range of nF (e.g., about 470 nF), whereas the super capacitor 52 has a capacitance in the range of mF or greater (e.g., less than about 500 mF, such as about 200 mF). As mentioned above, the system 50 operates in a plurality of modes to charge the super capacitor 52 to achieve and maintain a desired V_{OUT}.

The system 50 includes a linear regulator 62 that is electrically connected to the terminal 54 at which V_{OUT} is provided. The system 50 also includes a charge pump 64 that is electrically coupled to the terminal 54. The linear regulator 62 and the charge pump 64 cooperate to maintain V_{OUT} at a desired level, including when a corresponding input voltage V_{MX} falls below the desired level of V_{OUT}. The linear regulator 62 operates to maintain V_{OUT} at the desired level, such as by generating V_{OUT} at the desired level or, if V_{MX} is below the desired level, by charging V_{OUT} up to the available V_{MX}. Those skilled in the art will understand and appreciate various topologies of linear regulators that can be utilized.

The charge pump 64 is operative to provide supplemental charging of the super capacitor 52 during a low power mode, including when V_{MX} falls below the desired output level of V_{OUT}. For instance, assuming that the device implementing the system 50 is turned off so that V_{REG}=0 V, if V_{MX} is less than the desired voltage level for V_{OUT}, the charge pump 64 can be activated to supplement the charging being performed by the linear regulator 62. The charge pump 64 is utilized to charge V_{OUT} to the predetermined level when the available input voltage V_{MX} to the linear regulator 62 is insufficient to enable the linear regulator 62 itself to adequately charge the super capacitor 52 (e.g., when V_{MX}<V_{OUT}). When V_{OUT} exceeds a maximum voltage capacity of the linear regulator 62 for a given V_{MX}, the linear regulator 62 is deactivated and a corresponding pass device (e.g., including one or more transistors) is turned off to electrically disconnect V_{OUT} from V_{MX}. When the linear regulator 62 is turned off, the charge pump 64 may continue to charge the super capacitor 52 provided that V_{IN} from the battery remains above a low voltage threshold, which is required for operation of the charge pump. Additional logic conditions can also be utilized to enable operation of the charge pump 64, such as based on V_{MX} relative to an internal voltage generated by the linear regulator 62.

A control block 66 is operative to control the charge pump 64 so that the charge pump does not charge the super capacitor 52 to a voltage V_{OUT} that exceeds a maximum rating of the super capacitor. The control block 66 thus can deactivate the charge pump 64 if V_{OUT} exceeds a reference voltage. In the example of FIG. 2, the control block 66 controls the state of charge pump 64 based on a fixed reference voltage (V_{REF}) relative to a voltage that is proportional to V_{OUT}. The state of the charge pump 64 can be modified periodically based upon a pulse of a clock input signal, indicated at CLK_MON. For example, the CLK_MON signal can be (e.g., provided by a counter or a clock generator) a pulse at a frequency of about 2 Hz or other low rate to provide for periodically monitoring V_{OUT} and enabling or disabling the charge pump based thereupon. The lower frequency helps mitigate drain on the super capacitor 52 or the battery during the low power and back-up modes.

In the example of FIG. 2, the control block 66 includes a voltage divider comprising resistors 68 and 70 that are configured for providing a corresponding voltage to an input to a comparator 72. The reference voltage V_{REF} is provided to the other input of the comparator 72. The comparator 72 provides a corresponding comparator output signal to a flip-flop (DQ flip-flop) 74 that is activated by CLK_MON. The output of the flip-flop 74 thus provides control signal that enables the charge pump 64 when V_{OUT} is below a predetermined high voltage level and disables the charge pump when V_{OUT} is at or above the predetermined high voltage level. For example, the voltage divider of resistors 68 and 70 can be tuned according to the voltage rating of the super capacitor 52 so that the charge pump does not charge the super capacitor above its rated voltage.

The reference voltage V_{REF} is provided by a reference generator 76. The reference generator 76, for example, can correspond to a band gap voltage generator that provides V_{REF} as a temperature independent reference voltage. Those skilled in the art will understand and appreciate other types of circuitry that can be utilized to generate a suitable reference voltage. The reference generator 76 provides the reference signal V_{REF} based on upon an input voltage V_{IN}, such as is provided from the battery 78. The battery 78, for example, can be a rechargeable battery that may be integrally connected with or be removable from a device implementing the power system 50.

The battery 78 also provides V_{IN} to an input of a multiplexer 82. A voltage regulator 84 provides a regulated voltage V_{REG} to another input of the multiplexer 82. The regulated voltage V_{REG}, for example, can be provided by a converter 84, such as a DC-DC converter (e.g., a boost converter), as is known in the art. The converter 84 generates the regulated voltage V_{REG} as a substantially fixed, nominal DC voltage based on the V_{IN}. The converter 84 can further provide the regulated voltage to various circuit components, including internal and external loads, such as core circuitry of the device implementing the back-up power supply system 50. The multiplexer 82 provides the V_{MX} output by selecting one of the V_{REG} and V_{IN} according to which input voltage is greater. For example, if V_{REG}>V_{IN}, then V_{MX}≈V_{REG} (less any voltage drops across the multiplexer or other associated circuitry). In contrast, V_{IN}>V_{REG}, such as when the associated device has been turned off, then V_{MX}≈V_{IN}. V_{MX} thus corresponds to a variable input voltage that is provided to the linear regulator 62 and the charge pump 64.

The back-up power supply system 50 or integrated circuitry associated therewith also includes an internal load 86. The internal load 86 employs V_{OUT} as its operating power source for energizing associated components. As an example, the internal load 86 can include a real time clock, which can be utilized to maintain a real time clock for operating critical circuitry of the associated device implementing the power system 50. The internal load 86 can also include registers or memory that may require power to maintain values stored therein during the low power and back-up modes. Those skilled in the art will understand and appreciate other types of critical components that can also be implemented as the internal load 86 and take advantage of the super capacitor 52 charged to V_{OUT} according to an aspect of the present invention.

During the back-up mode, such as which occurs in circumstances when the linear regulator 62 and charge pump 64 do not charge the super capacitor 52, the super capacitor 52 can provide power to the internal load 86. As described herein, the linear regulator 62 and charge pump 64 are deactivated during the back-up mode so that they do not drain current from the super capacitor 52. As a result, the charge on the super capacitor 52 can be utilized during the back-up mode solely for powering the internal load 86.

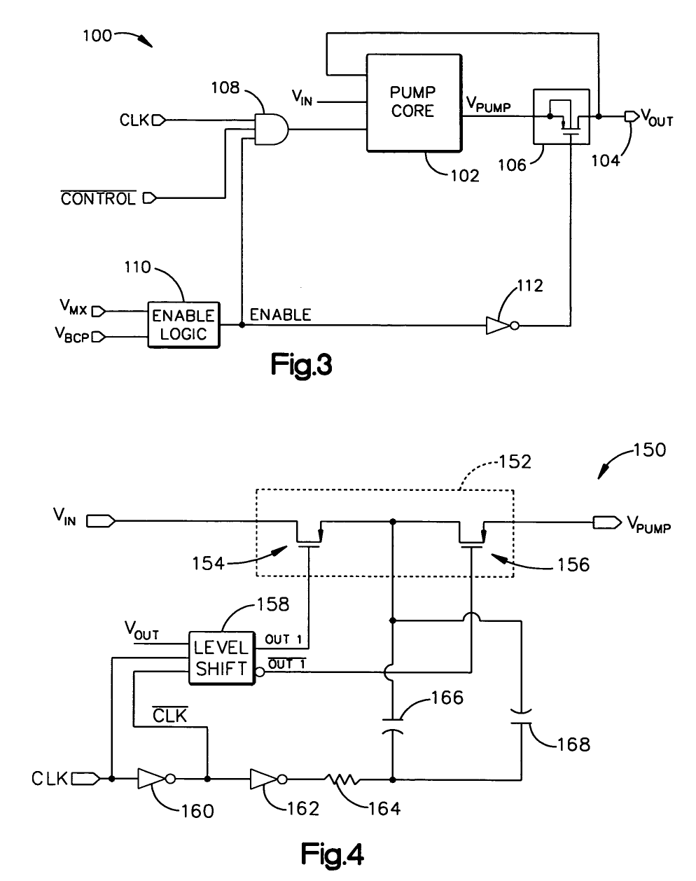

By way of further example, FIGS. 3-5 depict schematic diagrams for portions of a back-up power supply system that can be implemented according to an aspect of the present invention. Those skilled in the art will understand and appreciate other implementations that can be utilized based on the description contained herein.

FIG. 3 depicts an example of a charge pump system 100 that can be implemented in accordance with an aspect of the present invention. The charge pump system 100 includes a pump core 102 that is coupled to an output node 104 through a corresponding switch device 106. For example, the switch device 106 can be implemented as a P-type metal oxide semiconductor (PMOS) device. The pump core 102 provides a corresponding output voltage indicated at V_{PUMP}.

The pump core 102 provides V_{PUMP} based on the output voltage V_{OUT} provided at the terminal 104 and based on a clock input signal. The pump core 102 is configured to provide V_{PUMP} at a voltage that can be greater than the input voltage V_{IN}, which corresponds to the battery voltage as described herein. Those skilled in the art will understand and appreciate various designs and topologies of pump cores that can be utilized to generate V_{PUMP} to be greater than V_{IN} (see, e.g., FIG. 4).

In the example of FIG. 3, an AND-gate 108 provides a clock signal to operate the pump core 102. The AND-gate 108 provides the clock signal based on an input clock signal (CLK), based on an inverted version of a CONTROL signal, such as from the control block 66 of FIG. 2, and based on an ENABLE signal. That is, the pump core 102 is activated to generate V_{PUMP} commensurate with the CLK signal, provided that the CONTROL signal is low (e.g., the inverted version is high) and the ENABLE signal is also high.

An enable logic block 110 provides the ENABLE signal based on V_{MX} and V_{BCP}. V_{MX} is provided by a multiplexer based on a regulated input voltage V_{REG} and a battery input voltage V_{IN} (e.g., V_{MX}≈max (V_{REG}, V_{IN})), such as described herein. V_{BCP} corresponds to an internal voltage associated with a linear regulator that also cooperates with the charge pump system 100 to contribute to at least some of the voltage at V_{OUT}. V_{BCP} provides a reference voltage that indicates generally whether the linear regulator is able to charge the super capacitor up to about the desired output voltage. The enable logic 110 thus compares V_{MX} relative to V_{BCP} and provides the ENABLE signal as logic high, whenever V_{MX} is not sufficiently greater than V_{BCP}.

When V_{MX} is sufficiently greater than V_{BCP} (e.g., by a predetermined amount, such as about a diode drop), the enable logic 110 provides the ENABLE signal as a logic low voltage signal. The low ENABLE signal is provided to an inverter 112. The inverter 112 inverts the ENABLE signal to provide a control input signal to the PMOS device 106. Thus, when the ENABLE signal is low, the output of the inverter is a high input signal that turns off the PMOS device 106 and, in turn, disables the output of the charge pump system 100. However, if the V_{BCP} is within a predetermined level relative to V_{MX}, the enable logic 110 provides the ENABLE signal as a high logic signal to the AND-gate 108 and to the inverter 112. The inverter 112 inverts the high ENABLE signal and provides a logic low signal to turn on the PMOS device 106, thereby activating the charge pump system 100. As mentioned above, those skilled in the art will understand and appreciate various types of charge pump circuitry that can be utilized in a power supply system according to an aspect of the present invention.

FIG. 4 depicts one example of a charge pump core 150 that can be implemented in a charge pump system, such as the system 100 of FIG. 3. The pump core 150 includes an output stage 152 that includes a pair of switch device, depicted as respective PMOS devices 154 and 156. In this example, the pump core 150 comprises a voltage doubler pump circuit; although other types and configurations of charge pump cores could be utilized. The source of the PMOS device 154 is coupled to the drain of P_{MOS} 156 in series between V_{IN} and V_{OUT}. Those skilled in the art will understand and appreciate that the body (or intrinsic) diodes of the respective PMOS devices coupled in this manner can be arranged so as to prevent current flow through the output stage 152 from V_{PUMP} through V_{IN} when the PMOS devices 154 and 156 are turned off. Additionally, the PMOS device 106 of FIG. 3 and its body diode prevent current flow through the body diodes of PMOS devices 154 and 156 (FIG. 4) when V_{IN} is much higher than V_{OUT} and the charge pump is turned off.

A level shifter 158 is operative to control the PMOS devices 154 and 156 in a substantially mutually exclusive manner. The level shifter controls the respective PMOS devices 154 and 156 based on the output signal V_{OUT} (e.g., voltage provided to charge the super capacitor), based upon on a clock (CLK) signal and based on an inverted version of the clock signal (\overline{CLK}). The clock signal CLK is provided to a first inverter 160 that provides the inverted clock signal \overline{CLK} to the level shifter 158 and to another inverter 162. The level shifter 158 provides a pair of output signals indicated at OUT1 and \overline{OUT1}. OUT1 is provided to the PMOS device 154 and \overline{OUT1} is provided to the PMOS device 156. In this way, each of the PMOS devices 154 and 156 are activated out of phase with each other according to the duty cycle of the clock signal CLK (e.g., 50%).

A capacitive network includes capacitors 166 and 168 connected in parallel. Those skilled in the art will appreciate other arrangements of capacitive networks having one or more capacitors could be employed in the pump core 150. The parallel capacitors 166 and 168 are coupled to a node between the PMOS devices 154 and 156. The inverter 162 provides the clock signal through a resistor 164 to another node of the capacitive network. By way of example, during a first portion of the clock signal when OUT1 is low, the PMOS device 154 is activated to the ON condition such that V_{IN} is provided through the capacitors 166 and 168. Another version of clock signal CLK is provided to the opposite terminals of the capacitors 166 and 168 thereby to increase the voltage drop across the capacitors during this charging phase. During the next half of the clock cycle, the level shifter 158 provides OUT1 to deactivate the PMOS device 154 and provides \overline{OUT1} to turn on the PMOS device 156. Upon activating the PMOS device 156, the charge stored across the capacitors 166 and 168 is provided as the V_{PUMP} output signal through the activated PMOS device 156. The V_{PUMP} signal, which is approximately twice V_{IN}, thus can be employed to charge a corresponding super capacitor, as described herein.

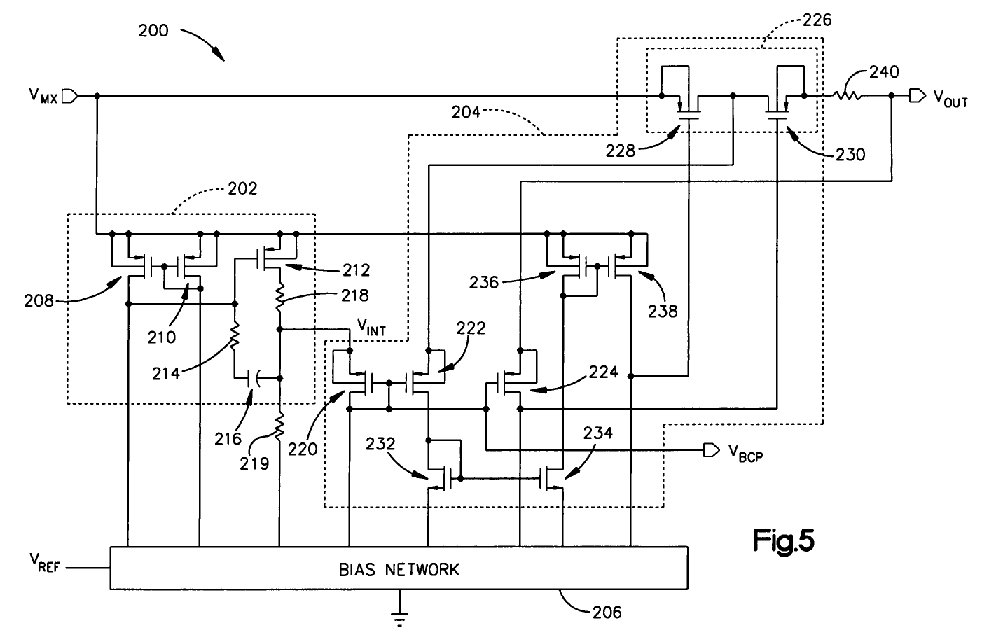

FIG. 5 depicts an example of a linear regulator system 200 that can be implemented according to an aspect of the present invention. The linear regulator system 200 provides V_{OUT} at a desired level based on V_{MX}. In particular, the linear regulator 200 provides V_{OUT} at about a predetermined level (e.g., about 3 V) if V_{MX} is greater than or equal to the predetermined level. However, when V_{MX} is less than the predetermined level, the linear regulator can provide the V_{OUT} up to about V_{MX}. V_{MX} can be provided by a multiplexer as the maximum of a regulated voltage V_{REG} and an input voltage (e.g., battery voltage V_{IN}).

The linear regulator 200 includes a first regulator portion 202 that is operative to provide an internal regulated voltage, indicated at V_{INT}. The first regulator portion 202, which itself can be considered a regulator, is configured to provide V_{INT} up to a predetermined voltage. V_{INT} corresponds to a reference voltage that is employed by a second regulator portion 204 of the regulator 200 to control V_{OUT}. The second regulator portion 204 of the linear regulator 200 is operative to provide V_{OUT} by controlling current flow to V_{OUT} based on V_{INT} and V_{OUT}. A bias network 206 is coupled to each of the respective regulator portions 202 and 204 for generating respective reference voltages and bias currents for enabling the regulating function performed by the respective regulator portions.

The first voltage regulator portion 202 includes an arrangement of PMOS devices 208, 210, and 212 coupled to the input V_{MX} for biasing an associated regulator loop and providing V_{INT} at a corresponding level. An RC network, which includes a resistor 214 connected in series with a capacitor 216, is coupled between a gate of the transistor 212 and to V_{INT}. The RC network 214, 216 provides the AC compensation for the first voltage regulator portion 202. The gate of transistor 212 further is coupled to the drain of the transistor 208 which is biased according to the bias network 206. Another resistor 218 is coupled between the V_{INT} node and the drain of the transistor 212, and a resistor 219 is coupled between V_{INT} and the bias network 206. The resistors 218 and 219 can be tuned so as to provide a desired reference voltage level at V_{ENT}, provided that V_{MX} is greater than the predetermined level to which the first regulator portion 202 is tuned.

V_{INT} is provided as an input to the second regulator portion 204. The second regulator portion 204 includes a comparator formed of a pair of transistors (PMOS devices) 220 and 222 having common gates, and with the gate of the PMOS device 220 coupled to its respective drain. The respective sources of the PMOS devices 220 and 222 correspond to inputs of the comparison function. The source of the PMOS device 220 receives the reference voltage V_{INT} from the first regulator portion 202. The source of the PMOS device 222 is coupled to receive an input signal from a node of an output stage 226 of the second regulator portion 204.

The output stage 226 includes a pair of PMOS devices 228 and 230 connected in series between V_{MX} and V_{OUT}. An intermediate node between the respective PMOS devices 228 and 230 thus provides the input at the source of the PMOS device 222. If the voltage at the intermediate node approximates V_{INT}, the drain of transistor 222 is pulled high. A corresponding transistor (NMOS device) 232 is biased based on drain of the PMOS device 222. The NMOS device 232 forms part of a current mirror coupled to activate another transistor (NMOS device) 234 to pull current from an output bias network formed of transistors (PMOS devices) 236 and 238. Specifically, when the NMOS device 234 is turned on, the gate of the PMOS device 236 is pulled low to conduct current through the PMOS device 236 and NMOS device 234. The gate of PMOS device 238 is also pulled low through NMOS device 234, such that the gate of the PMOS device 228 of the output stage 226 is pulled high through PMOS device 238.

When the gate of the PMOS device 228 is high, the PMOS device 228 is turned off to prevent current flow from V_{MX} to V_{OUT}. In contrast, if V_{INT} is higher than the voltage at the intermediate node between the PMOS devices 228 and 230, the output bias network of transistors 236 and 238 is deactivated, such that the gate of the output PMOS device 228 is pulled low. When the gate of the output PMOS device 228 is pulled low, current can flow through the PMOS device 228 to charge V_{OUT} up to about V_{MX}, provided that the PMOS device 230 also is turned on.

The gate of PMOS 220 is also provided to the gate of the PMOS device 224, which further operates as a second comparator for controlling the second PMOS device 230 of the output stage 226. In particular, the PMOS device 224 is coupled to control the gate of the transistor 230 based on the relative levels of V_{INT} and V_{OUT}, which is provided at the source of PMOS device 224. For example, if the gate-to-source voltage of the PMOS device 224 exceeds its bias threshold, the PMOS device 224 is turned on, such that the drain of the PMOS device 224 is pulled high to V_{OUT}. This, in turn, causes the gate of the output stage PMOS device 230 to go high, which turns off the PMOS device 230. The PMOS device 224 can be made weaker (e.g., having the same channel length but a smaller width) than PMOS device 220 such that the voltage threshold of the second comparator is higher than V_{INT}. The respective body (intrinsic) diodes of the PMOS devices 228 and 230 are arranged such that current cannot conduct from the V_{OUT} to V_{MX} or from V_{MX} to V_{OUT} when the PMOS devices 228 and 230 of the output stage 226 are turned off. The PMOS device 230 thus operates as a blocking switch to prevent current flowing through the body diode of PMOS device when V_{OUT} exceeds V_{MX}. A resistor 240 is connected between the output stage 226 and V_{OUT}. The resistor 240 is a very low resistance (e.g., about 5Ω) and is used for AC compensation of the second regulator portion 204.

The second regulator portion 204 also provides an internal voltage V_{BCP} corresponding to the gate of the transistor 220. The internal voltage V_{BCP} defines a reference voltage employed by the charge pump circuit, such as described with respect to FIG. 3.

FIG. 6 is a graph depicting examples of electrical signals that can be provided in a back-up power supply system implemented according to an aspect of the present invention. In particular, FIG. 6 depicts an input voltage V_{IN} 250 (e.g., corresponding to a battery voltage) increasing from zero to about two volts and being maintained at the two volt level, such as corresponding to a low power mode. The output voltage V_{OUT}, indicated at 252, is utilized to charge an associated super capacitor. In FIG. 6, the output voltage V_{OUT} increases commensurate with V_{IN} over a first portion of the illustrated time period. A regulated voltage V_{REG} is indicated at 254. This regulated voltage 254 increases from zero to over 5 V. With regulated voltage 254 at or exceeding the predetermined threshold for V_{INT} (e.g., about 3 V), the linear regulator operates (e.g., in a normal operating mode) to charge the output voltage 252 to about 3 V.

In the example illustrated in FIG. 6, the regulated voltage 254 quickly reduces from greater than 5 V to about zero volts at a time prior to charging V_{OUT} and the super capacitor coupled thereto to the desired level. The reduction in the regulated voltage 254 to zero, for instance, may occur in response to the device implementing the power supply being turned off. When the main power supply that supplies the regulated voltage 254 is turned off, the back-up power supply, including the linear regulator and charge pump are employed to provide power to internal load(s) that require power.

Thus, the charge pump is enabled and activated to continue charging V_{OUT} 252. The charge pump remains activated to charge V_{OUT} up to when a corresponding output voltage monitor detects that the output voltage 252 has reached a predetermined maximum output voltage threshold indicated at time 256. That is, the charge pump remains activated in the on condition to charge the associated super capacitor and increase the V_{OUT} over a time period indicated at 258. Over the next time period, indicated at 260, the charge pump is disabled. The super capacitor can be utilized to provide power to internal circuitry, such as real time clocks and other components requiring back-up power. After the output voltage V_{OUT} 252 falls below a predetermined threshold, indicated at time 262, the charge pump is again turned on for charging the super capacitor back up to the predetermined maximum output voltage.

Those skilled in the art will understand and appreciate that the time periods illustrated in FIG. 6 are for purposes of illustration only and that typically the discharging and charging of the super capacitor can occur over longer periods of time, such as minutes or even hours. The exact time will depend on the RC time constant provided by the ESR of the super capacitor, the value of the capacitance and the internal load. From the foregoing, those skilled in the art will further appreciate that buy utilizing a charge pump for a low power operation, a lower rated (e.g., less expensive) super capacitor can be utilized than many traditional systems that employ a voltage regulator as the sole means for charging the super capacitor. The reduced cost of the super capacitor typically will exceed the additional cost for implementing the charge pump in the circuit. Additionally, the use of a low current linear regulator and charge pump, according to an aspect of the present invention, will represent a power savings in comparison to a traditional boost regulator that would need to be on all the time to maintain the super capacitor charged to the desired voltage. This will impact directly the battery lifetime. Additional efficiencies can be achieved since the output stage or pass devices of the linear regulator are used to isolate V_{OUT} from V_{MX}, which further mitigates discharging of the super capacitor when the linear regulator is turned off and the charge pump is activated.

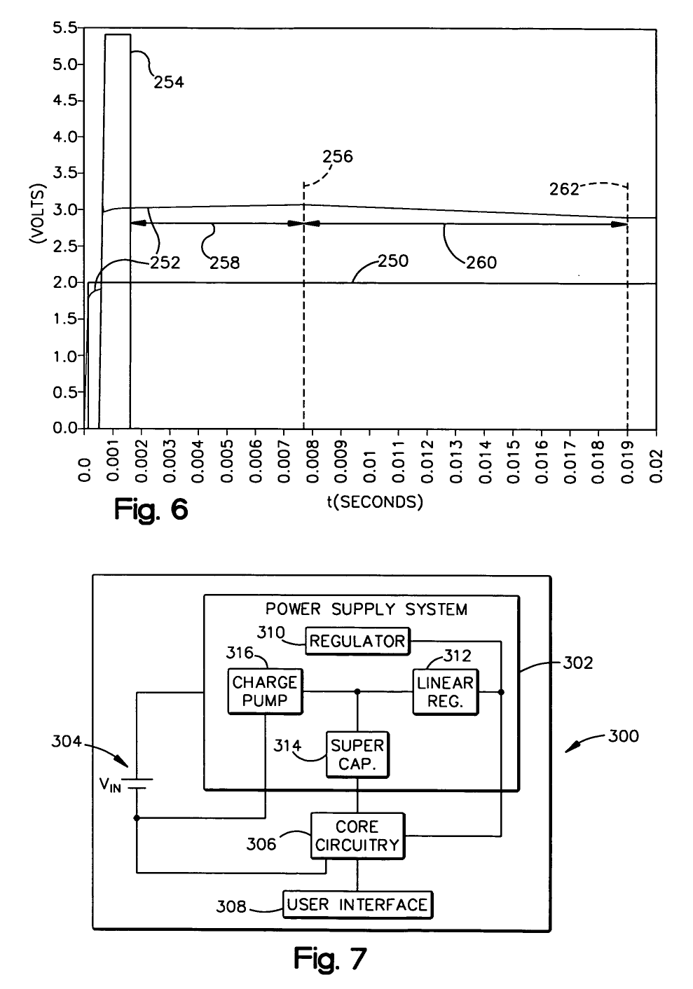

FIG. 7 depicts an example of a portable electronic apparatus 300, such as a digital camera, digital audio recorder, a cellular telephone, personal digital assistant, portable computer and the like, which implements a back-up power supply system 302 according to an aspect of the present invention. Those skilled in the art will understand and appreciate various implementations for the power supply system 302 based on the teachings contained herein, including but not limited to those shown and described with respect to FIGS. 1-6.

The power supply system 302 is coupled to a battery 304 for converting an input voltage V_{IN} from the battery to a desired level. The power supply system 302, for example, provides regulated power to associated core circuitry 306, which power can vary based on an operating mode of the apparatus 300. The core circuitry 306 can include analog or digital components configured and/or programmed to implement the functionality of the particular type of apparatus 300 being implemented. In the example of FIG. 7, a user interface 308, which can include hardware and/or software, is coupled to the core circuitry 306 for providing input instructions from a user to the core circuitry.

By way of example, the apparatus 300 can operate in a plurality of operating modes, including at least a normal operating mode, a low power or sleep mode and a back-up mode. The power supply system 302 thus includes circuitry operative to provide power requirements according to the operating mode. The power supply system 302 can include a voltage regulator 310 that operates during the normal operating mode to supply power (a regulated voltage) to the core circuitry 306. A linear regulator 312 also is provided to provide power to other internal loads of the core circuitry 306, as well as to a super capacitor 314, based on the regulated voltage from the regulator 310 during the normal mode. In the normal mode, for example, the linear regulator 312 provides an output voltage to the super capacitor 314 that is less than the regulated voltage from the regulator 310. The power supply system 302 also includes a charge pump 316 that is operative, during a low power mode, to charge the super capacitor 314 for supplying power to internal loads of the core circuitry 306. The charge pump can cooperate with the linear regulator 312 for charging the super capacitor 314, such as described herein. In this way, an increased charge can be provided for providing power to associated internal loads of the core circuitry 306 during a low power mode.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A back-up power supply system, comprising:
a switch system coupled to provide an output voltage for charging a back-up power device up to about a predetermined voltage based on an input voltage; and
a charge pump coupled to provide a pump signal to the output voltage for charging the back-up power device up to about the predetermined voltage based on the output voltage exceeding the input voltage.

2. The system of claim 1, wherein the switch system further comprises a voltage regulator that provides the output voltage at a voltage that is one of about the input voltage and about the predetermined voltage.

3. The system of claim 2, wherein the voltage regulator further comprises a pass device coupled between the input voltage and the output voltage, the pass device being operated to provide the output voltage up to about the predetermined voltage based on the output voltage and the input voltage.

4. The system of claim 3, wherein the pass device is activated to electrically isolate the input voltage from the output voltage during a low power mode that occurs when the output voltage exceeds about the input voltage.

5. The system of claim 2, further comprising a multiplexer that provides the input voltage at a higher voltage selected from a battery voltage and a regulated input voltage from a converter.

6. The system of claim 5, wherein the back-up power device further comprises a super capacitor coupled to the output voltage, the super capacitor having a voltage rating that is less than the regulated input voltage from the converter.

7. The system of claim 2, wherein the voltage regulator comprises a linear voltage regulator comprising:
a first regulator portion that generates an internal regulated voltage based on the input voltage;
a second regulator portion that provides at least one control signal based on the output voltage relative to the internal regulated voltage; and
an output stage that provides the output voltage based on the at least one control signal.

8. The system of claim 7, wherein the first regulator portion is configured to provide the internal regulated voltage at a voltage that is one of about the input voltage and about the predetermined voltage.

9. The system of claim 8, further comprising an enable system that enables the charge pump to increase the output voltage based on the output voltage relative to the internal regulated voltage.

10. The system of claim 1, further comprising a control system that provides a control signal for selectively activating the charge pump based on the output voltage relative to a predetermined reference voltage.

11. The system of claim 1, wherein the back-up power device further comprises a super capacitor coupled to the output voltage, such that at least one of the switch system and the charge pump is operative to charge the super capacitor up to about the predetermined voltage.

12. A portable electronic device comprising the system of claim 11.

13. An integrated circuit comprising the back-up power supply system of claim 1, the integrated circuit further comprising an internal load that is powered according to the output voltage associated with the back-up power device.

14. A back-up power supply system, comprising:
a linear regulator that receives a variable input voltage, the linear regulator providing an output voltage at a lower one of the input voltage and a predetermined voltage;
a charge pump coupled to increase the output voltage up to about the predetermined voltage based on the linear regulator being unable to provide the output voltage at the predetermined level given the input voltage; and
a super capacitor coupled at the output voltage, the super capacitor being charged by at least one of the linear regulator and the charge pump up to about the predetermined voltage.

15. The system of claim 14, wherein the linear regulator further comprises:
a first regulator portion that generates an internal regulated voltage based on the input voltage;
a second regulator portion that provides at least one control signal based on the output voltage relative to the internal regulated voltage; and
an output stage that provides the output voltage based on the at least one control signal.

16. The system of claim 15, wherein the first regulator portion is configured to provide the internal regulated voltage at a voltage that is one of about the input voltage and about the predetermined voltage.

17. The system of claim 16, further comprising an enable system that enables the charge pump to increase the output voltage based on the output voltage relative to the internal regulated voltage.

18. The system of claim 16, further comprising a control system that deactivates the charge pump if the output voltage exceeds a predetermined reference voltage.

19. The system of claim 14, further comprising a multiplexer that provides the variable input voltage at a higher voltage selected from a battery voltage and a nominal regulated input voltage from a converter.

20. The system of claim 19, wherein the super capacitor has a voltage rating that is less than the nominal regulated input voltage from the converter.

21. A back-up power supply system, comprising:
means for storing a charge;
means for providing an output voltage for charging the charge storage means up to about a desired output voltage based on an input voltage;
means for supplementing the charging of the charge storage means up to about the desired output voltage; and
means for controlling the means for supplementing based at least in part on an ability of the means for providing to charge the charge storage means up to about the desired output voltage.

22. The system of claim 21, wherein the means for controlling further comprises means for enabling the means for supplementing to charge the charge storage means based on the output voltage relative to an internal voltage of the means for providing indicating an inability to charge the charge storage means up to about the desired output voltage.

23. The system of claim 21, wherein the means for controlling further comprises means for deactivating the charge pump if the output voltage exceeds desired output voltage.

24. The system of claim 21, wherein the means for providing further comprises means for electrically isolating the output voltage from the input voltage.
